(19) United States
(12) Patent Application Publication
(10) Pub. No.: US 2014/0171842 A1
(43) Pub. Date: Jun. 19, 2014

(54) GSS MISSILE

(71) Applicants: Julie Marie Conner, Mount Vernon, WA (US); Kevin Conner, Mount Vernon, WA (US)

(72) Inventors: Julie Marie Conner, Mount Vernon, WA (US); Kevin Conner, Mount Vernon, WA (US)

(21) Appl. No.: 14/031,557

(22) Filed: Sep. 19, 2013

Related U.S. Application Data
(60) Provisional application No. 61/797,722, filed on Dec. 14, 2012.

(51) Int. Cl. A61H 23/00; A61H 19/00

(52) U.S. Cl. CPC A61H 23/00; A61H 19/44
USPC 601/46

(57) ABSTRACT

An adjustable personal vibrating stimulator includes a main handle portion, a middle portion connected to the main handle portion, a movable handle portion, a cylinder-shaped member connected to the movable handle portion, and a tip connected to the middle portion. The main handle portion is movable relative to the movable handle portion. The stimulator further includes a G spot stimulator disposed on said cylinder-shaped member, such that the G spot stimulator is movable relative to the tip. The handles can be moved in the same direction or once inserted, may be moved in opposing directions at the same time.

### CROSS REFERENCE TO RELATED APPLICATIONS

This application claims the priority of Provisional Application No. 61/797,722 filed on Dec. 14, 2012 for inventor Julie Marie Conner, “GSS Missile.” The entire disclosure of this provisional patent application is hereby incorporated by reference thereto, in its entirety.

### FIELD OF THE INVENTION

The present invention relates to a personal vibrating stimulator. More specifically, the invention relates to vibrating stimulators used as sexual aid devices.

### BACKGROUND OF THE INVENTION

Personal vibrating stimulators, for use as sexual aid devices, are generally known in the art. Such prior art devices typically have a power source such as a battery or electrical cord, a motor-powered vibrating element, and an electrical connection between the power source and the motor to cause vibration. The entire assembly is usually encased in a material suitable to contact with human skin and tissue, and is usually waterproof to protect the motor and power source from damage and to protect the user from shock. Such prior art devices are well known.

It is, however, a problem in the art to provide an adjustable personal vibrating stimulator with a manually actuatable movable portion for adjustable application to specific portions of the anatomy such as that known as a G-spot.

Traditional dildos are typically one vibrating or non-vibrating part that is vaginally inserted as a single unit. Traditional dildos require the woman and/or her sexual partner that is inserting the dildo to either focus on deep vaginal penetration or focus on stimulating the G-spot area but does not allow for simultaneous attention to the two distinct areas at the same time.

There is a need for a sex toy that responds to the two distinct erogenous zones within the vagina and allows each area to be stimulated separately consistent with the preferences of the participant. This multi-zone stimulation is for the purpose of enhancing sexual gratification.

### SUMMARY OF THE INVENTION

From the foregoing, it is seen that it is a problem in the art to provide a device meeting the above requirements. According to the present invention, a device and process are provided which meets the aforementioned requirements and needs in the prior art.

The present invention relates generally to sex products or sexual aid devices commonly referred to as sex toys. More particularly the present invention or device is comprised of numerous parts which create a two unit phallic device or dildo that allows the deep traditional phallic insertion which occupies the full vaginal cavity with one unit while the second unit separately and independently stimulates the erogenous zone area located one to three inches inside the vagina often referred to as the G-spot.

Throughout history sex toy devices, usually phallic in appearance have been utilized by women for vaginal penetration for the purpose of sexual gratification. The present invention enhances this sexual gratification by uniquely increasing stimulation to the G-spot, the most sensitive area of the vagina known to contain the most nerve endings, while simultaneously allowing for traditional deep vaginal stimulation.

The present invention is a sex toy whose infrastructure is comprised of two cylinder shaped units of varying lengths and dimensions. The two units are each comprised of multiple parts that form the two distinct units. The first unit is a comparatively longer cylinder shaped section that is comparatively smaller in dimension and circumference to the second unit. The second unit is a shorter cylinder shaped section that is comparatively larger in diameter and circumference compared to the longer cylinder shaped unit. The second unit is hollow. The size proportion is such that the first unit (the longer/smaller unit in circumference) slides easily back and forth through the center of the second unit (the shorter/larger in circumference unit). When the first unit is fully inserted through the center of the second unit, the tip of the first unit protrudes through the top of and out of the top of the second unit.

Each cylinder shaped unit has a handle on one side. The longer cylinder shaped unit has a tip designed to foster ease of penetration into the vaginal cavity. This tip can vary in size, shape, texture, contour, and material and may or may not contain a vibrating apparatus. Tips may vary and the tips are interchangeable.

The shorter second cylinder shaped unit has an elevated or raised protrusion on one side that is designed to make contact with and thus stimulate the G-spot. Hereafter, this will be referred to as the G-spot stimulator. The raised surface of the G-spot stimulator vibrates. The vibration is created by an internal motor that uses an offset weight attachment. The tip of the second unit which contains the G-spot stimulator is also designed to foster ease of penetration into the vaginal cavity because this portion of the invention may be inserted independently of the first unit portion of the invention that gets vaginally inserted first. The G-spot stimulator can vary in size, shape, texture, contour, and material. The same physical design could also be used in the invention without a vibrating apparatus.

The cylinder shaped units are designed and arranged such that when the first unit (the longer/thinner unit) is completely pushed through the center of the second unit (the shorter/thicker unit) the respective handles may touch exposing the uncovered end of the longer cylinder and the aforementioned tip attached thereto. This exposed section of the product will be equivalent in length to other traditional phallic devices or dildos. However, the girth of the unit will be relatively thin allowing for the stimulating surface of the second unit to have room to also be independently inserted as this portion of the device slides over the shorter cylinder. The length and girth of this portion of the product will be roughly equivalent to other traditional dildos. This design will allow for a double penetration or double thrusting into the same orifice before the product (or part of the product) is withdrawn.

The design intentionally allows for the thinner cylinder shaped unit's tip to be inserted into the vaginal cavity at a depth ranging from the vaginal entryway to the back of the vaginal cavity. The G-spot stimulator attached to the larger cylinder may be inserted from the entryway to the back of the vaginal cavity up to the back of the tip of the previously inserted portion of the product. These independent portions of the invention may be inserted separately at different times in the same direction or once inserted, may be moved in opposing directions at the same time.

Other objects and advantages of the present invention will be more readily apparent from the following detailed description when read in conjunction with the accompanying drawings.

### BRIEF DESCRIPTION OF THE DRAWINGS

FIG. 1 is a perspective top front view of an adjustable personal vibrating stimulator according to the present invention.

FIG. 2 is a perspective exploded view of the adjustable personal vibrating stimulator of FIG. 1, which includes a main handle portion and a movable handle portion, according to the present invention.

FIG. 3 is a perspective top rear view of the adjustable personal vibrating stimulator of FIG. 1.

FIG. 4 is a perspective bottom-front view of the device of FIG. 1.

FIG. 5 is a side view of the device of FIG. 1.

FIG. 6 is a top view of the device of FIG. 1.

FIG. 7 is a bottom view of the device of FIG. 1.

FIG. 8 is a perspective view of a handle portion of the stimulator of FIG. 1 shown connected to a hollow top portion by a middle cylindrical portion.

FIG. 9 is a perspective view of a motor and an offset weight, which is used in the device of FIG. 1.

FIG. 10 is a perspective view of an actuator element having an extending portion, used in the device of FIG. 1.

FIG. 11 is a perspective view of an assembly of the motor and offset weight of FIG. 9 with the actuator element of FIG. 10.

FIG. 12 is a perspective view of the motor assembly of FIG. 11 shown in phantom as mounted within the hollow top portion of FIG. 8.

FIG. 13 is a side view of the arrangement shown in FIG. 12.

FIG. 14 is a side elevational view of the arrangement of FIG. 13 installed in the hollow top portion shown in FIG. 8.

FIG. 15 is a perspective view of a hollow cylinder-shaped member which has an opening, and which fits on one end of the movable handle portion shown in FIG. 2.

FIG. 16 shows assembly of the hollow cylinder-shaped member of FIG. 15 with the movable handle portion of FIG. 2.

FIG. 17 is a perspective view of a shaft bellows in compressed form, used in the device of FIG. 2.

FIG. 18 is a side view of the shaft bellows of FIG. 17 in expanded form.

FIG. 19 is a side view of the device of FIG. 1 in which the G spot stimulator is in a forward extended position.

FIG. 20 is a side view of the device of FIG. 19 in which the G spot stimulator is in a retracted position.

FIG. 21 is a side view corresponding to FIG. 19, with an indication depicting a typical vaginal insertion region.

FIG. 22 is a side view corresponding to FIG. 20, with an indication depicting the typical vaginal insertion region.

FIG. 23 is a rear perspective view of a tip element shown in FIG. 2.

### DETAILED DESCRIPTION OF THE INVENTION

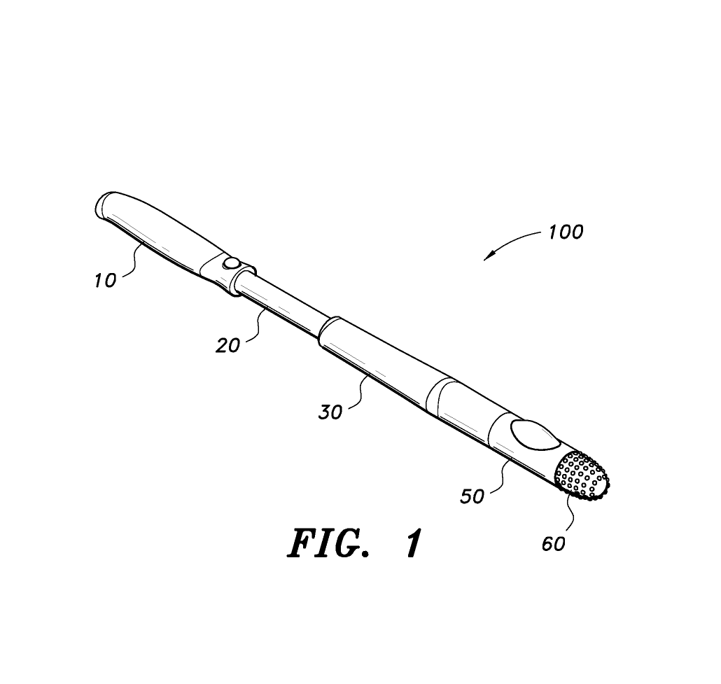

FIG. 1 is a perspective top front view of an adjustable personal vibrating stimulator 100, according to the present invention. The stimulator 100 has a main handle portion 10, a middle portion 20, a movable handle portion 30, a cylinder-shaped member 50, and a tip 60. These are described in further detail hereunder.

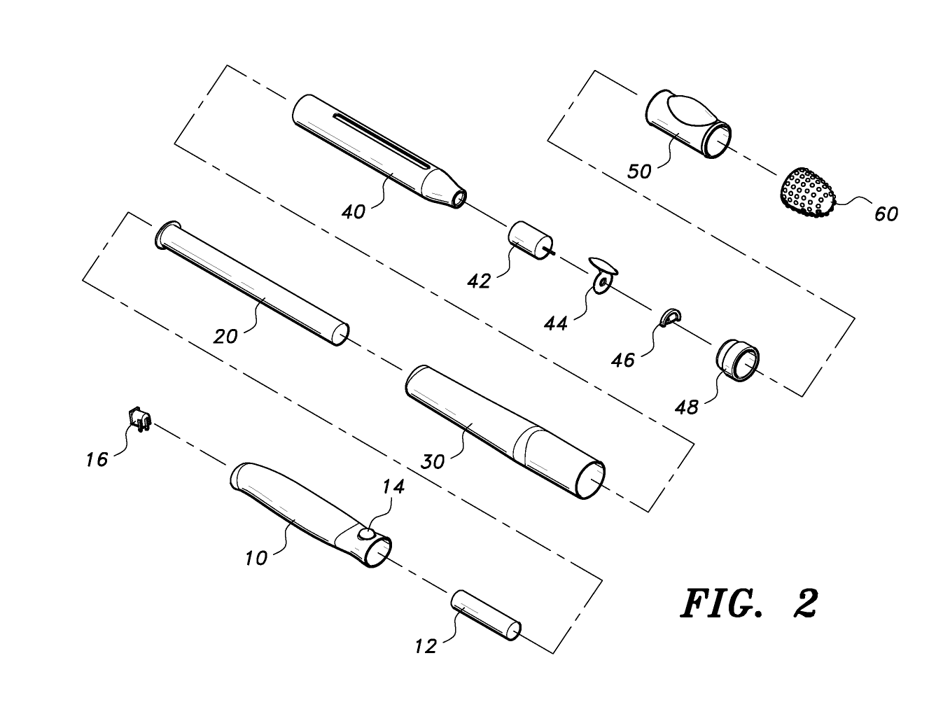

FIG. 2 is a perspective exploded view of the adjustable personal vibrating stimulator 100 of the above-described FIG. 1, showing the main handle portion 10, a battery 12, the middle portion 20, the movable handle portion 30, a hollow top portion 40, a motor 42, an actuator 44, an offset weight 46, a shaft bellows 48 in compressed form, the cylinder-shaped member 50 having a protrusion 52 (shown and numbered in FIG. 13), and the tip 60.

In the above, the handle portion 10, the middle portion 20, the hollow top portion 40, and the tip 60 together are defined for purposes of discussion as a first unit. The movable handle 30 and the hollow cylinder-shaped member 50 together are defined for purposes of discussion as a second unit, which is movable relative to the first unit. The first unit is a comparatively longer cylinder shaped section that is comparatively smaller in dimension and circumference to the second unit.

Throughout history sex toy devices, usually phallic in appearance have been utilized by women for vaginal penetration for the purpose of sexual gratification. The present invention enhances this sexual gratification by uniquely increasing stimulation to the G-spot, the most sensitive area of the vagina known to contain the most nerve endings, while simultaneously allowing for traditional deep vaginal stimulation.

The present invention is a sex toy whose infrastructure is comprised of two cylinder shaped units of varying lengths and dimensions. The two units are each comprised of multiple parts that form the two distinct units. The first unit is a comparatively longer cylinder shaped section that is comparatively smaller in dimension and circumference to the second unit. The second unit is a shorter cylinder shaped section that is comparatively larger in diameter and circumference compared to the longer cylinder shaped unit. The second unit is hollow. The size proportion is such that the first unit (the longer/smaller unit in circumference) slides easily back and forth through the center of the second unit (the shorter/larger in circumference unit). When the first unit is fully inserted through the center of the second unit, the tip of the first unit protrudes through the top of and out of the top of the second unit.

The longer cylinder shaped unit has a tip 60 designed to foster ease of penetration into the vaginal cavity. This tip can vary in size, shape, texture, contour, and material and may or may not contain a vibrating apparatus. Tips 60 may vary and the tips 60 are interchangeable.

The shorter second cylinder shaped unit has an elevated or raised protrusion 52 on one side that is designed to make contact with and thus stimulate the G-spot. Hereafter, this will be referred to as the G-spot stimulator 52. The raised surface of the G-spot stimulator 52 vibrates. The vibration is created by the internal motor 42 that uses the offset weight 46. The tip of the second unit which contains the G-spot stimulator is also designed to foster ease of penetration into the vaginal cavity because this portion of the invention may be inserted independently of the first unit portion of the invention that gets vaginally inserted first. The G-spot stimulator 52 can vary in size, shape, texture, contour, and material. The same physical design could also be used in the invention without a vibrating apparatus.

The material used for the G spot stimulator can, for example, be silicone or a similar product that will allow the vibrations from the vibrating mechanism (elements 42, 44, 46) to be felt through the material of the G spot stimulator 52 which is formed as a concave covered vibrating mechanism.

The cylinder shaped units are designed and arranged such that when the first unit (the longer/thinner unit) is completely pushed through the center of the second unit (the shorter/thicker unit) the respective handles 10, 30 may touch, exposing the uncovered end of the longer cylinder and the aforementioned tip 60 attached thereto. This exposed section of the device will be equivalent in length to other traditional phallic devices or dildos. However, the girth of the unit will be relatively thin allowing for the stimulating surface of the second unit to have room to also be independently inserted as this portion of the device slides over the shorter cylinder. The length and girth of this portion of the product will be roughly equivalent to other traditional dildos. This design will allow for a double penetration or double thrusting into the same orifice before the product (or part of the product) is withdrawn.

The design intentionally allows for the thinner cylinder shaped unit's tip 60 to be inserted into the vaginal cavity at a depth ranging from the vaginal entryway to the back of the vaginal cavity. The G-spot stimulator 52 attached to the larger cylinder 50 may be inserted from the entryway to the back of the vaginal cavity up to the back of the tip of the previously inserted portion of the device. These independent portions of the invention may be inserted separately at different times in the same direction or once inserted, may be moved in opposing directions at the same time.

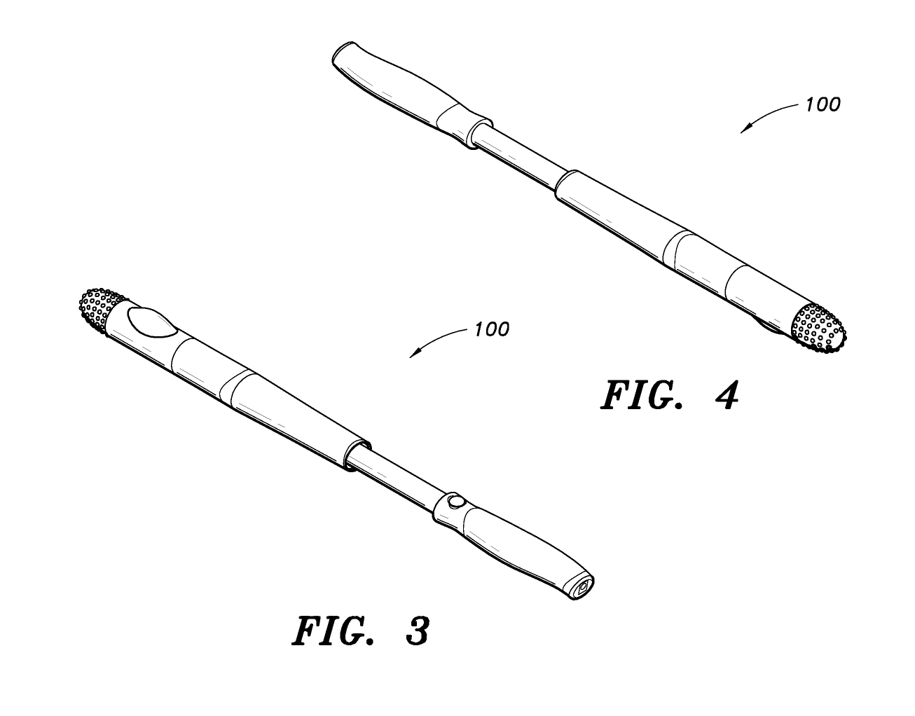

FIG. 3 is a perspective top rear view of the adjustable personal vibrating stimulator 100 of FIG. 1.

FIG. 4 is a perspective bottom-front view of the stimulator 100 of FIG. 1.

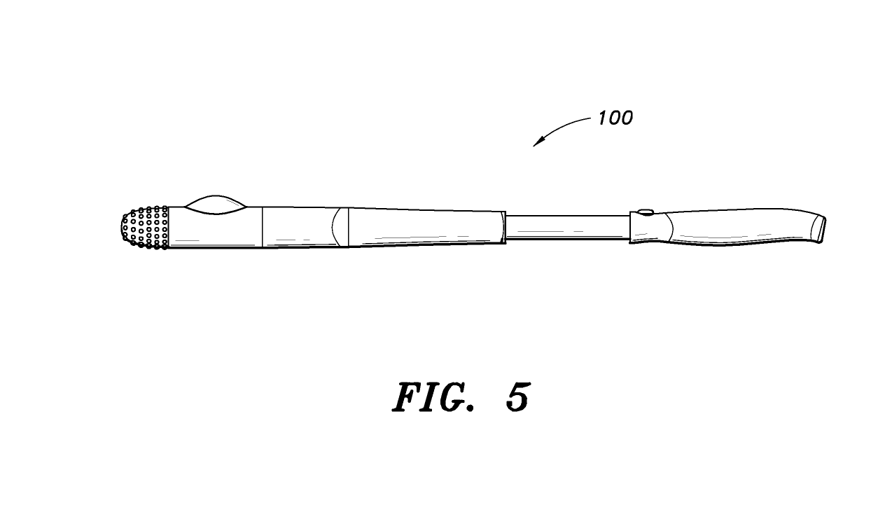

FIG. 5 is a side view of the stimulator 100 of FIG. 1.

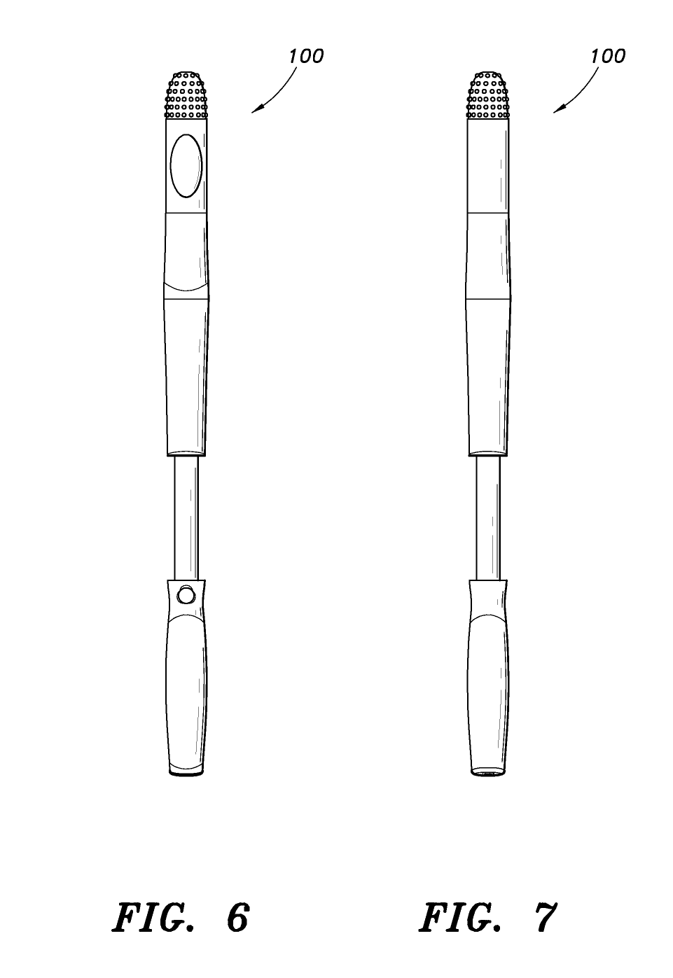

FIG. 6 is a top view of the stimulator 100 of FIG. 1.

FIG. 7 is a bottom view of the stimulator 100 of FIG. 1.

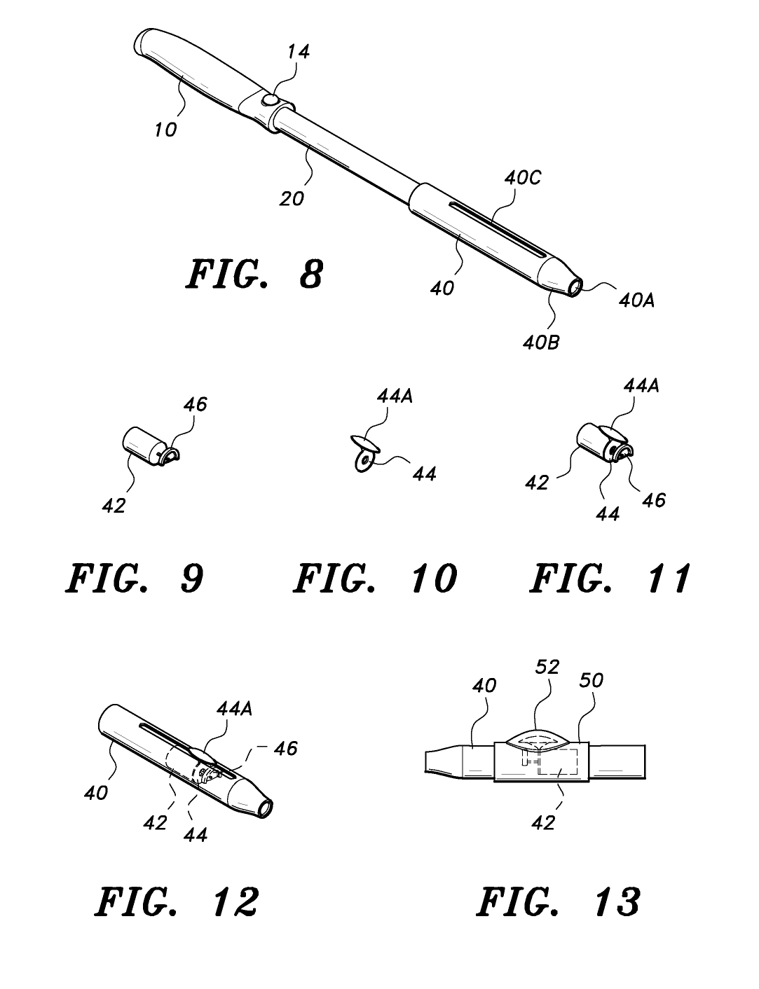

FIG. 8 is a perspective view of the handle portion 10 of the stimulator 100 of FIG. 1 shown connected to the hollow top portion 40 by the middle cylindrical portion 20. As seen in FIG. 8, the hollow top portion has a tip 40A, a tapered end portion 40B, and a slot 40C. The tip 40A is adapted for attachment to the tip 60, and is shown as hollow.

The attachment of the tip 60 in the preferred embodiment is as shown and described with respect to FIG. 20. Furthermore, in one variation, the hollow top portion 40 can receive a protrusion (not shown) from the bottom of the tip 60 for convenient removable attachment and detachment, or in another variation could include an insert member (not shown) between the hollow top portion 40 and the tip 60. Such attachments are conventional and may be varied within this art, and are therefore not shown for the sake of clarity; such attachments are within the ambit of any one having skill in the vibrating sex toy arts.

As seen in FIG. 8, the handle 10 also includes a speed control button 14. This allows for control of speed of the motor 42. The specific speed control mechanism and wiring are conventional and therefore not shown for the sake of clarity; such wiring and speed control mechanisms are within the ambit of any one having skill in the vibrating sex toy arts.

FIG. 9 is a perspective view of the motor 42 and the offset weight 46, which is used in the device 100 of FIG. 1.

FIG. 10 is a perspective view of the actuator element 44 having an extending portion 44A, used in the device 100 of FIG. 1.

FIG. 11 is a perspective view of an assembly of the motor 42 and the offset weight 46 of FIG. 9 combined with the actuator element 44 of FIG. 10. In operation, the motor 42 and offset weight 46 cause vibrations which are transferred to the actuator element 44 which in turn vibrates the G spot stimulator 52.

FIG. 12 is a perspective view of the motor assembly of FIG. 11 shown in phantom view as mounted within the hollow top portion 40 of FIG. 8.

FIG. 13 is a side view of the arrangement shown in FIG. 12.

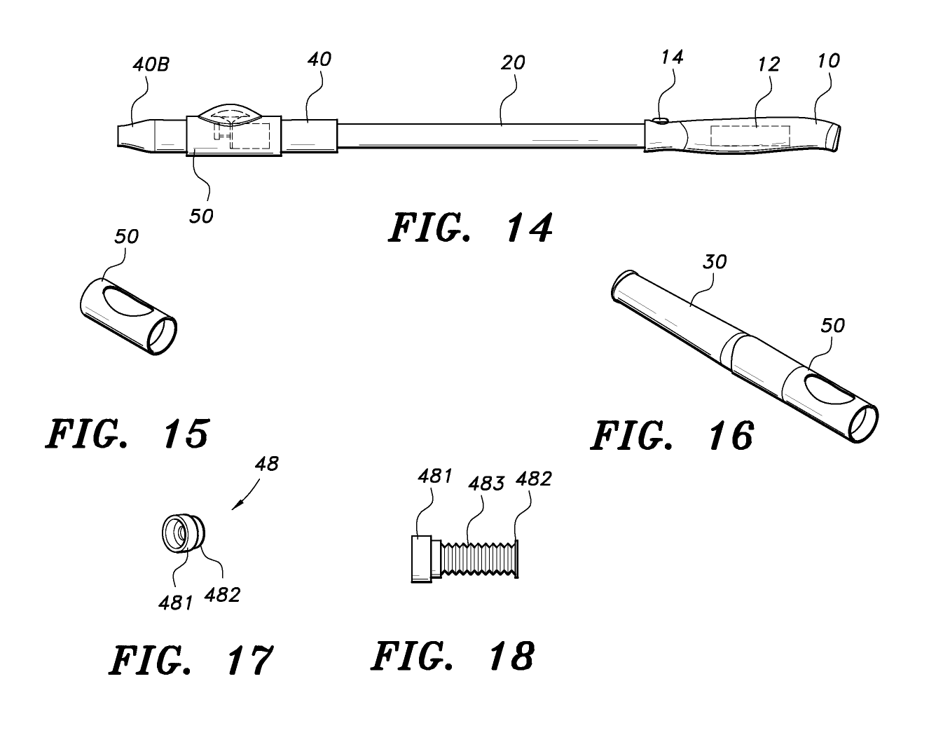

FIG. 14 is a side elevational view of the arrangement of FIG. 13 installed in the hollow top portion shown in FIG. 8. The battery 12 is shown in phantom outline in this view. The G spot stimulator 52 is shown mounted on the hollow cylinder-shaped portion 50.

FIG. 15 is a perspective view of the hollow cylinder-shaped member 50 which has an opening therein (through which the extension portion 44A extends), and which fits on one end of the movable handle portion 30 shown in FIG. 2.

FIG. 16 shows assembly of the hollow cylinder-shaped member 50 of FIG. 15 with the stimulator handle portion 30 of FIG. 2.

FIG. 17 is a perspective view of the shaft bellows 48 in compressed form, used in the device 100 of FIG. 2. The shaft bellows 48 has a first end 481 and a second end 482.

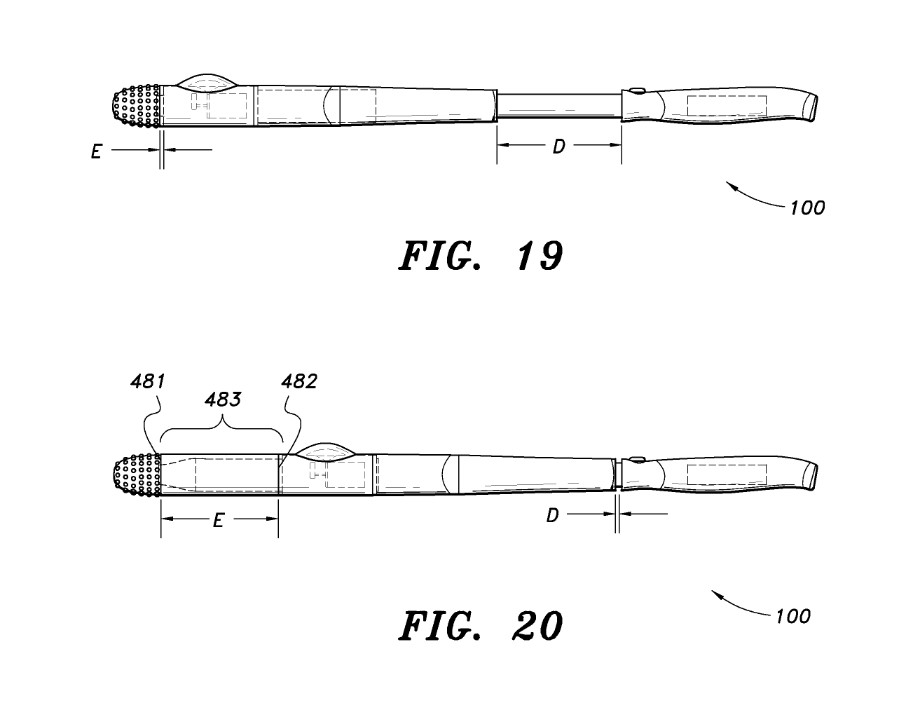

FIG. 18 is a side view of the shaft bellows 48 of FIG. 17 in expanded form. The shaft bellows 48 includes a central bellows portion 483 which connects the first end 481 to the second end 482. In use, the central bellows portion 483 covers the gap between the tip 60 and the proximal edge of the hollow cylinder-shaped member 50. The central bellows portion 483 is preferably very thin, though the thickness can be varied.

FIG. 19 is a side view of the device of FIG. 1 in which the G spot stimulator 52 is in a forward extended position. This means that the main handle portion is separated from the moveable handle portion by a distance D, and the hollow cylinder-shaped member 50 is separated from the tip 60 by a distance E. Here, the distance E is nearly zero.

FIG. 20 is a side view of the device of FIG. 19 in which the G spot stimulator 52 is in a retracted position. This means that the main handle portion is separated from the moveable handle portion by a distance D which has become nearly zero, and the hollow cylinder-shaped member 50 is separated from the tip 60 by a distance E which corresponds to the same distance as that shown for D in FIG. 19. Thus, FIGS. 19 and 20 clearly show the movement of the above-defined first and second units relative to one another.

FIG. 20 shows the details of the shaft bellows 48 in expanded form as mounted on the device 100. As shown, the tip 60 (unnumbered in this view for the sake of clarity) is attached to the first end 481 of the shaft bellows. The central bellows portion 483 is in its expanded condition, and the second end 482 is also shown and is connected to the member 50 (unnumbered in this view for the sake of clarity) for movement therewith. Thus, movement of the member 50 relative to the tip 60 results in expansion (FIG. 20) or contraction (FIG. 19) of the central bellows portion 483.

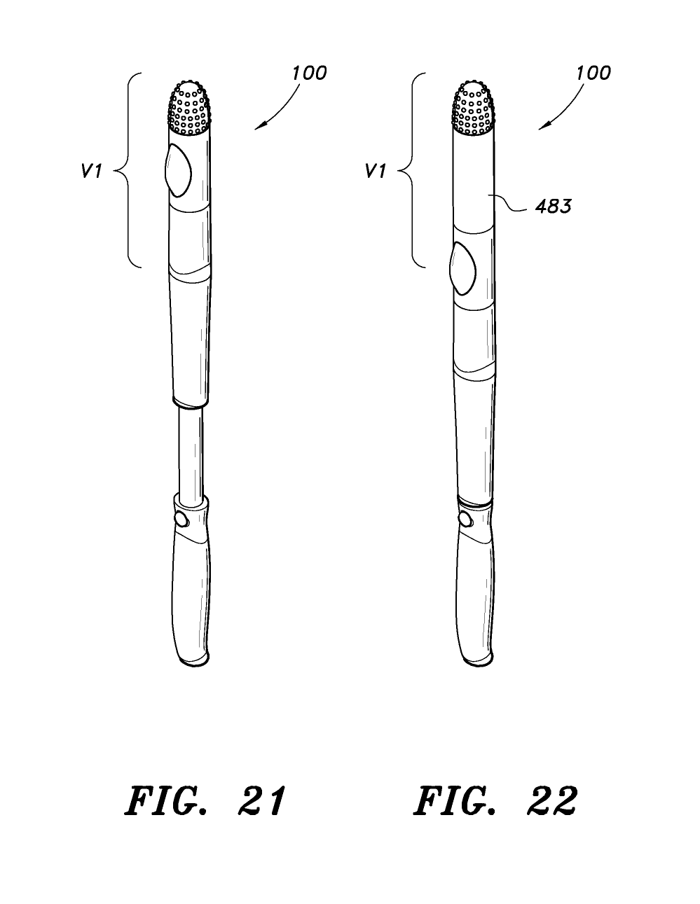

FIG. 21 is a side view corresponding to FIG. 19, with an indication depicting a typical vaginal insertion region labeled “V1”, which corresponds to dimensions of a typical vaginal cavity. This is depicted for purposes of illustration only, and it will be understood that the actual size of the vaginal cavity may vary from one individual to another.

FIG. 22 is a side view corresponding to FIG. 20, with an indication depicting the typical vaginal insertion region V1.

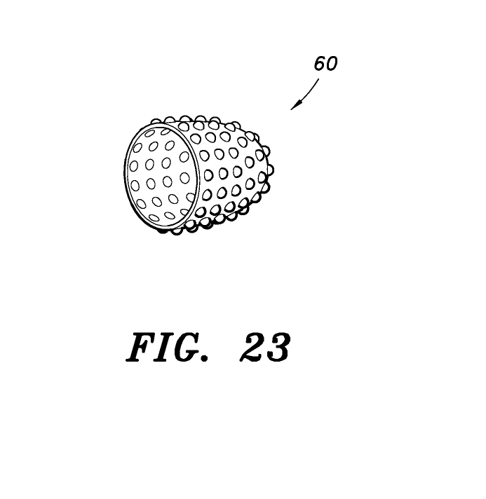

FIG. 23 is a rear perspective view of the tip 60, which is shown in FIG. 2. As seen, in the preferred embodiment the tip 60 is a hollow member.

When the handle portions 10, 30 are together, the tip 60 may be vaginally inserted as a single unit traditional dildo. When the handles 10, 30 are apart, the handle 30 is movable so as to serve as a second phallic device that can now also be vaginally inserted independently. This second unit is attached to the motorized stimulator 52. The handles 10, 30 can be moved independently of one another so the area located at the back of the vaginal cavity can be stimulated with the tip 60 at a different speed or pressure from the G-spot area located closer to the vaginal entry which can be stimulated with the stimulator 52. Independent of the full, deep vaginal insertion of the tip 60, the stimulator 52 may be inserted and removed from the vaginal cavity during use.

Mechanically, when the main handle 10 is held in place, the movable handle 30 can be slid up and down. Likewise, the movable handle 30 can be held in place and the main handle 10 can be moved up and down.

The handles 10, 30 are designed with respect to size to allow them to be grabbed by an average human adult hand. The grips should be made from a material conducive to being wrapped around cylinder shaped units that will provide a comfortable grip for each hand. The finished product 100 can be made from any material commonly used for sexual aid products.

The device 100 can be used by a female lying on her back with a partner who will be operating the invention sitting between her legs approximately in the area of her knees. The product 100 is lined up with the vagina and the tip 60 is inserted vaginally. The handle portions 10, 30 are independently controlled to cause the tip 60 and the G-spot stimulator 52 to be moved into and out of the vagina in a back and forth manner.

The invention being thus described, it will be evident that the same may be varied in many ways. Such variations are not to be regarded as a departure from the spirit and scope of the invention and all such modifications are intended to be included within the scope of the claims.

What is claimed is:

1. An adjustable personal vibrating stimulator, comprising:
a main handle portion,
a middle portion connected to the main handle portion,
a movable handle portion,
a cylinder-shaped member connected to the movable handle portion, and
a tip connected to the middle portion;
whereby the main handle portion is movable relative to the movable handle portion.

2. The stimulator of claim 1, further comprising a G spot stimulator disposed on said cylinder-shaped member; whereby the G spot stimulator is movable relative to the tip.
